(19) United States
(12) Patent Application Publication
(10) Pub. No.: US 2007/0143443 A1
(43) Pub. Date: Jun. 21, 2007

(54) OUTSOURCED BURNING, PRINTING AND FULFILLMENT OF DVDS

(75) Inventor: Tomasz Johannsen, San Diego, CA (US)

Correspondence Address: Tomasz Johannsen, 3937 via Cangrejo, Suite B, San Diego, CA, 92130, US

(73) Assignee: Englaze, Inc, San Diego, CA (US)

(21) Appl. No.: 11/306,188

(22) Filed: Dec. 19, 2005

(51) Int. Cl. G06F 15/16

(52) U.S. Cl. 709/218

(57) ABSTRACT

A method for electronically submitting a DVD order for burning and printing at a remote location is provided. The present invention allows software applications that burn DVD discs through a local DVD-ROM drive to easily integrate a virtual DVD publishing device. The virtual DVD publishing device allows users to order small numbers of DVDs directly from the application. The DVD order is submitted electronically over the Internet and is fulfilled at a DVD fulfillment center that burns content onto a blank DVD, prints professional quality graphic images onto the DVD and ships the finished DVD product to its intended recipients. Through economies of scale not available to the individual user of a DVD software application, the DVD fulfillment center is able to use sophisticated and expensive printing technologies to produce economically a high resolution, full color DVD print that will not smudge and will not run when moistened.

### FIELD OF THE INVENTION

This invention relates to the electronic submission of DVD fulfillment orders that include printing a custom image onto the DVD.

### BACKGROUND OF THE INVENTION

There are many DVD authoring software applications available that allow users to create DVD content and burn the content onto blank DVDs. The applications range from expensive, professional software suites to simple, inexpensive consumer programs. All of these applications enable a user to burn a DVD using a locally attached DVD-ROM drive with WRITE capabilities. At the present time, most new home or office computer systems include writable DVD-ROM drives, and many multimedia computers contain pre-installed DVD authoring software. It is therefore fairly easy for many computer owners to create DVDs with custom or personalized content.

It is also possible for a home or office computer user to create a full color disc label on the DVD. There are two general approaches available today: The first entails printing the disc image onto a sheet with an adhesive label, removing the label from the sheet and affixing it onto the disc. The problem with this method is that the ink on the label will run if the disc is inadvertently sprinkled with a liquid (such as a beverage). The second approach entails printing directly to the disc with an inkjet printer (many inkjet printers have a special slot for printing directly to a CD or DVD). The problem with the inkjet method is that the ink smudges when rubbed with a finger. In both methods, the final product has an obvious home-made appearance that looks less professional than a store bought CD or DVD.

A professional quality print image has the same qualities as the print image on a CD or DVD purchased through a retail store: it is full color, it covers the entire printable area of the disc, it does not smudge when rubbed with a finger and the colors do not run should the disc get wet. Professional quality CD/DVD printing systems, such as the thermal printers offered by Rimage Corporation, are presently very expensive and require special training to operate them.

Disc Replication and Duplication services will create professional quality print surfaces for CD and DVD copies, but their pricing and business model make this economically feasible for order quantities that exceed several hundred units. Some Disc Replication and Duplication centers offer limited electronic order submission services. For example, Mimeo allows users to create custom graphics to print onto blank DVD discs, but it doesn't allow DVD content to be submitted electronically. So a user wishing to make less than 20 copies with a professional quality print surface does not have an economical way to produce the discs. There are an estimated 500 million users of DVD authoring software and many of them will run into this problem sooner or later.

### SUMMARY OF THE INVENTION

In view of the foregoing, a prime object of the present invention is to provide a DVD ordering and fulfillment method that automates the production of small batches (short runs) of unique DVDs that have professional quality surface printing.

Another object of the present invention is to provide a method that can be integrated directly into DVD authoring applications for the convenient and electronic submission of DVD fulfillment orders.

Another object of the present invention is to provide the custom DVD ordering and fulfillment method at a sufficiently low cost such that the DVDs can be sold for less than the retail price of typical DVDs available at retail stores.

These and other objects, advantages, and novel features according to the present invention are provided by a method of electronically submitting a DVD fulfillment order to a fulfillment center, pre-processing each order into standard components using an automated system, burning and printing the DVD using automated software and equipment, and shipping the completed DVD to one or more recipients. Through economies of scale and automation, the fulfillment center uses expensive DVD printing equipment to economically fulfill DVD orders for small quantities of discs, including orders of a single disc.

It is a feature of the present invention wherein the user is prompted to select one or more images to be printed on the DVD, and the user is able to optionally add text fields to be printed on the disc. Prior to submitting the DVD order, the user is shown a preview of the final DVD print layout and is able to approve it or make corrections before submitting it. Once approved, the image(s) and optional text fields are submitted as part of the DVD order.

It is a further feature of the present invention wherein the user is explicitly asked to confirm that the spelling in all text fields is correct.

It is a further feature of the present invention wherein the user is explicitly asked to approve the selection of the image(s) to be printed on the DVD.

It is another feature of the present invention wherein the user can select one or more digital files as content for burning onto the DVD. The files are submitted as part of the DVD order. The digital files can be individual image, video and music files that require additional processing by the fulfillment center to create the final DVD content. Alternatively, the digital file can be an ISO image file that is burn ready and that does not require additional rendering or processing by the fulfillment center.

It is an additional feature of the present invention wherein shipping information may be submitted together with the DVD order so that the completed DVD(s) can be shipped directly to their intended recipients via the U.S. Postal service or courier service such as Federal Express, UPS or DHL.

It is a further additional feature of the present invention wherein payment information may be submitted together with the DVD order so that no additional paperwork or communication between the buyer and service provider is required for production and shipment of the DVD(s).

It is a feature of the pre-processing step wherein the images and text fields for printing on the DVD surface are compiled into a single, standard image file. This facilitates the automated printing step that follows.

It is an additional feature of the pre-processing step wherein the individual digital content files are processed into a standard ISO image file which can be burned directly onto a blank DVD. This facilitates the automated burning step that follows.

It is another feature of the present invention wherein a standardized XML API for submitting the DVD order allows for the invention to be integrated easily into existing DVD authoring application software.

It is a further feature of the present invention wherein the entire DVD order is transmitted over the Internet.

### BRIEF DESCRIPTION OF THE DRAWINGS

FIG. 1 is an illustration of a Photo DVD slideshow creation application.

FIG. 2 is an illustration of the DVD print configuration screen of the Photo DVD slideshow application.

FIG. 3 is a network diagram showing the DVD fulfillment center at a remote location from the offices where the DVD orders are being placed.

FIG. 4 is a Flow Chart that illustrates the key steps in the method described in this invention.

### DETAILED DESCRIPTION OF THE PREFERRED EMBODIMENT

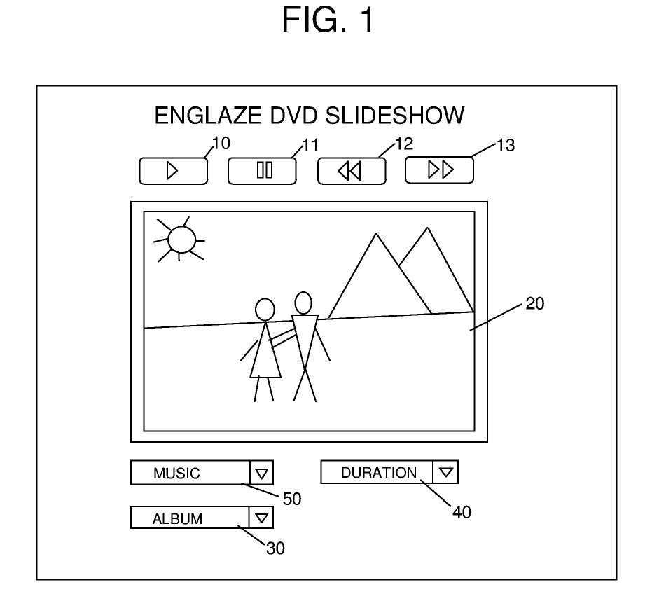

Referring now to FIG. 1, there is illustrated the first screen of a Photo DVD Slideshow creation application. In the present embodiment, the application is written in Macromedia FLASH and made available on a web page so that it can be accessed by most Web Browsers. The application has a simple user interface that shows each photo for 5 to 10 seconds and then transitions to the next photo. The application shows various motion transition effects such as fading, zooming, panning and rotating the images to add interest to the slideshow. The application displays exactly the same sequence of photos and transition effects as will appear on the final DVD so the user can see what the DVD content will look like. The user can control the playback of the slideshow images using the play 10 button, the pause 11 button, the rewind 12 and fast-forward 13 buttons. The Album 30 dropdown list control allows the user to select a different set of images for the slideshow. The Duration 40 dropdown list control allows the user to change the duration of each slide and the Music 50 dropdown list control allows the user to select background music for the slideshow.

The Photo DVD slideshow application shown in FIG. 1 essentially allows the user to define the content that will play on the DVD, in this case a photo slideshow. Other types of DVD authoring applications allow the creation of video content such as full length commercial movies or personal home video clips, for example: Adobe's Encore, Sonic's DVDit, PhotoDex's ProShow. Still other types of DVD authoring applications allow the creation of business slideshow presentations based on a Microsoft PowerPoint document. It is important to note that whatever the type of content defined, configured or created, the method of this invention allows this content to be incorporated into the electronically submitted DVD order. The details of how this incorporation is accomplished are discussed later in the paragraphs about the XML order specification.

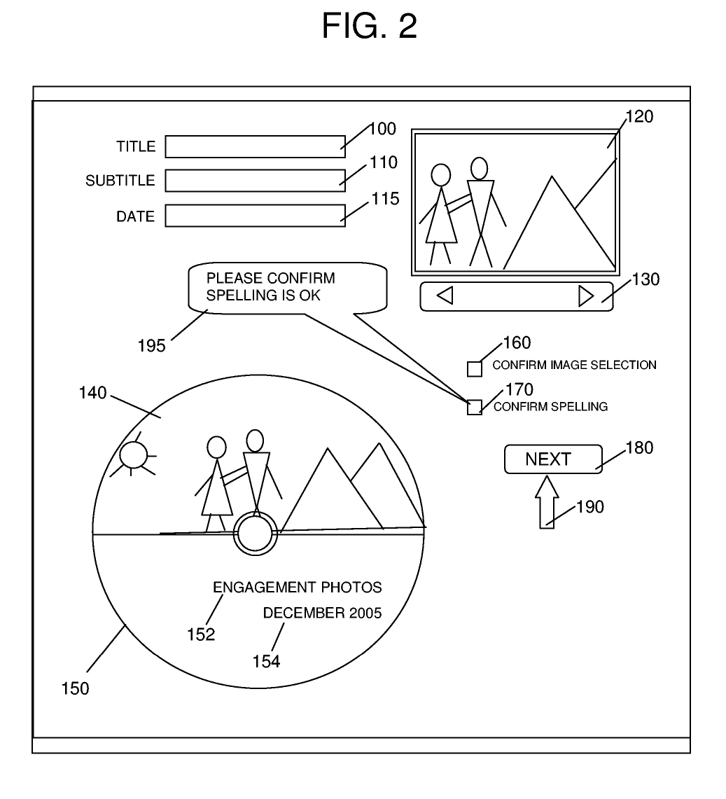

Once the DVD content is defined, the next step is for the user to define what appears on the printable surface of the DVD. FIG. 2 shows the DVD surface print configuration page of the Photo DVD Slideshow application shown earlier. Referring now to FIG. 2, the user is able to enter title for the DVD in the title field 100. Additional text information can be entered in the subtitle 110 and date 115 fields. The present embodiment of the invention is made using MacroMedia's FLASH language for web applications which allows changes to the text 100, subtitle 110 and date 115 fields to be shown to the user in real time on the DVD print preview 150 (the methods for which are well known in the art).

An important element of a professional quality DVD print surface is the presence of a full color image. In the present embodiment, the user can select a color photograph 120 from the series of photographs in the album using the forward and backward selection buttons 130. The color photograph 120 is shown on the DVD print preview 140 in real-time as the selection is made. In this way, the user is able to see an accurate and realistic preview of what the DVD print surface will look like after printing.

Once the user is satisfied with the appearance of the DVD print surface, the user presses the “Next” 180 button with the mouse pointer 190. If the user has not checked the “Confirm Spelling” checkbox 170, the application will present an error box 195 asking the user to explicitly confirm that the spelling in all the text fields is accurate and ready for printing. A similar procedure is followed with the “Confirm Cover Image Selection” checkbox 160 to ensure that the correct image has been selected for printing onto the DVD.

Once both checkboxes 160, 170 have been checked, the user presses the “Next” button 180 to continue with the order taking process. The user then enters shipping and credit card information, the methods for which are well known in the art and are not described herein.

The configuration of the DVD Case Insert (the paper that slides into the outside sheath of the DVD case) is done in a similar manner to the method described for the DVD print surface. The content for the booklet that is placed inside the DVD case is configured in a similar manner, or is contained in a computer document such as a Microsoft Word file.

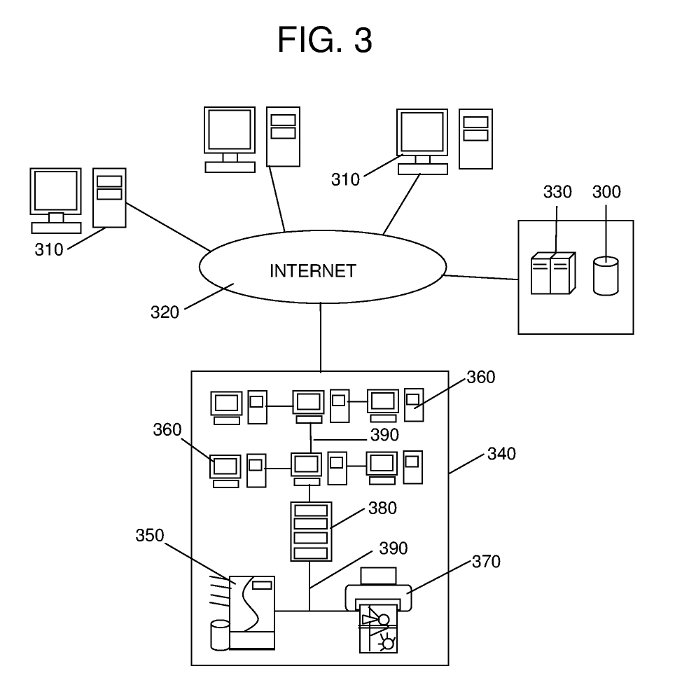

In order to benefit from economies of scale, DVD orders from multiple locations are submitted electronically over the Internet to a central (but not necessarily unique) DVD fulfillment center. A network diagram illustrating this architecture is shown in FIG. 3. Referring now to FIG. 3, the individual computers 310 are running various DVD authoring applications. The applications submit DVD orders electronically to a Web Server 330 and the content of the DVD orders is stored in a Database 300. The Web Server and Database are shown in a location that is distinct from the DVD fulfillment center 340 because that is the architecture of the present embodiment. However, the Web Server and Database can be co-located inside the DVD fulfillment center 340 without any substantive change the method of the present invention.

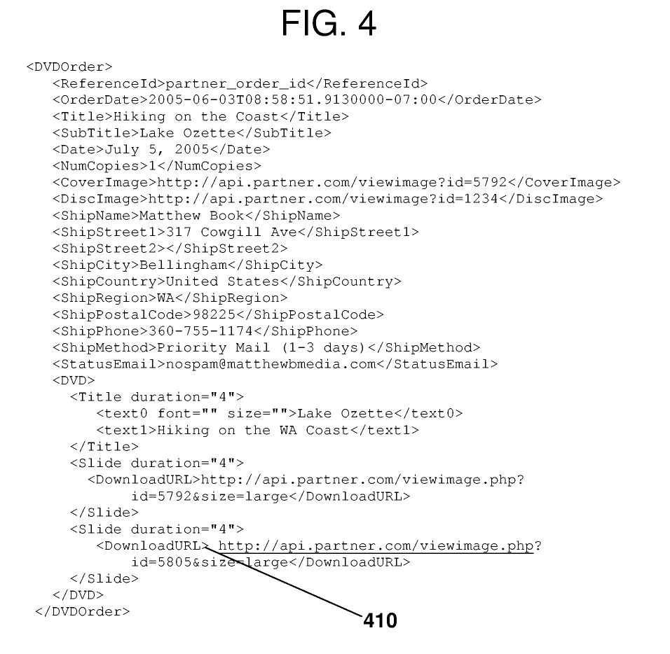

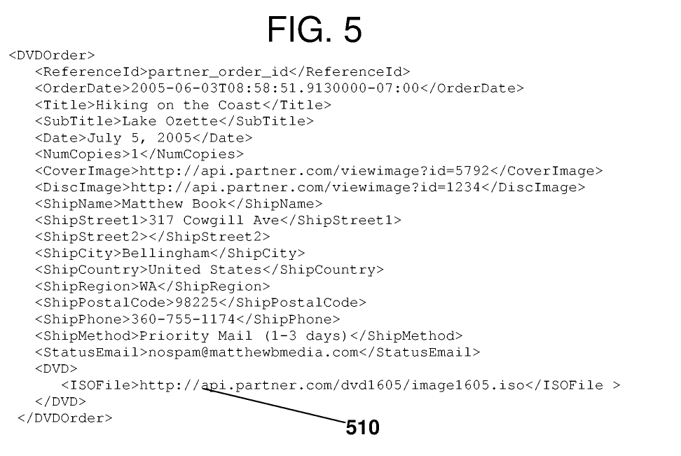

The format for the DVD order submission has been standardized into an XML syntax allowing multiple vendors of DVD authoring applications to easily integrate the DVD fulfillment service into their software applications. A sample DVD order XML listing is shown in FIG. 4 where the content consists of individual photos, specified by their individual URLs 410, that need to be processed into a burn-ready ISO file by the workstation 360. Note that the content of the digital files can vary according to the type of application that was used to create the DVD. For example, the files can be individual image files stored in common formats such as JPG, PNG, GIF, TIFF, BMP, or individual video files stored in common formats such as MPG, MPEG, WMV, MOV, AVI, or individual music files stored in common formats such as MP3, WMA, WAV, AU, or application specific project files that define how the aforementioned contents is assembled into a DVD burn-ready image file, or any combination of the above types of files.

FIG. 5 contains an XML listing where the ISO image file has already been created by the individual DVD authoring application. The URL location of the ISO file is contained in the <ISOFile> XML node 510.

The DVD fulfillment center has computer workstations 360 that receive the DVD orders from the Web Server 330 and perform any additional processing of the DVD content that is required. In the present embodiment, for example, the workstations 360 assemble the series of photos taken from a photo album specified by the user into a slideshow with transition effects and background music. The workstation 360 renders the slideshow into an MPEG2 stream, authors the DVD menu and then packages the burn-ready disc image into an ISO file (all according to methods well known in the art). In the present embodiment, an entire ISO may be submitted by the computer 310 running the DVD authoring application, in which case the ISO rendering step is skipped by the workstation 360.

The workstation 360 assembles the images and text fields for printing onto the disc and converts them into a single JPEG file with dimensions 2834×2834 pixels at a resolution of 600 dpi. Similarly, the DVD case insert and booklet content is converted into a single standard file format.

At this point, each DVD order has been standardized into a single ISO disc image file and a single JPEG print image file. The workstations 360 submit each order over a local area network 390 to a Rimage model RAS15E automated DVD publishing system 350. The Rimage disc publisher 350 burns the ISO image file onto a blank DVD disc and prints the corresponding JPEG image file using a thermal printer onto the surface of the disc.

The DVD case inserts are printed on an EPSON Stylus Photo RX600 printer 370. The DVDs are placed into their respective cases, packaged and shipped to their recipients. Each step of this process is controlled and recorded by the workstations 360 and status updates are submitted to the Database 300 for storage.

The invention is not limited to DVDs, but also includes CDs other disc media. For example, many websites today offer music downloads. None of these websites currently offer consumers ability to create a music CD with customer selected music tracks and customer selected disc image. The present invention would allow an economical way for offering this kind of service.

The invention has been described in detail with particular reference to certain preferred embodiments thereof, but it will be understood that variations and modifications can be effected within the spirit and scope of the invention.

What is claimed is:

1. A method of electronically submitting a DVD fulfillment order to a fulfillment center comprising the steps of:
i) Displaying a preview of the printed DVD surface that shows the layout of user selected images and user text as they will be printed on the DVD surface;
ii) Electronically submitting one or more said digital images to be printed onto the surface of the DVD;
iii) Electronically submitting zero or more said text fields to be printed onto the surface of the DVD;
iv) Electronically submitting one or more digital files to be burned as content onto the DVD;
v) Electronically submitting shipping information for the recipient of the DVD which includes the address of the recipient;
vi) Receiving the images, text fields and digital files at the fulfillment center;
vii) Burning the digital files as content onto a blank DVD;
viii) Printing the image(s) and text fields, if any, onto said DVD's printable surface;
ix) Shipping said DVD to the provided shipping address.

2. The method according to claim 1 further comprising submitting the quantity of DVDs to be produced.

3. The method according to claim 1 further comprising submitting payment information that includes a credit card number and expiration date.

4. The method according to claim 1 wherein said DVD preview step further comprises explicitly requesting user confirmation that all spelling in the text fields is correct.

5. The method according to claim 1 wherein said DVD preview step further comprises explicitly requesting user confirmation that the correct image(s) have been selected for printing.

6. The method according to claim 1 wherein said electronic submission steps further comprise submitting the DVD order, the cover image(s), the text field(s) and the digital content files over the Internet.

7. The method according to claim 1 further comprising integration with a software application that typically burns DVD content through a local DVD-ROM drive, to serve as a virtual DVD printing and burning device for said software application.

8. A business process which allows a software application that has DVD burning capabilities to burn and print a DVD remotely through a virtual DVD publication device comprising the steps of:
i) Displaying a preview of the printed DVD surface that shows the layout of user selected images and user text as they will be printed on the DVD surface;
ii) Electronically submitting one or more said digital images to be printed onto the surface of the DVD;
iii) Electronically submitting zero or more said text fields to be printed onto the surface of the DVD;
iv) Electronically submitting one or more digital files to be burned as content onto the DVD;
v) Electronically submitting shipping information for the recipient of the DVD which includes the address of the recipient;
vi) Receiving the images, text fields and digital files at the fulfillment center;
vii) Burning the digital files as content onto a blank DVD;
viii) Printing the image(s) and text fields, if any, onto said DVD's printable surface;
ix) Shipping said DVD to the provided shipping address.

9. The method according to claim 8 further comprising submitting the quantity of DVDs to be produced.

10. The method according to claim 8 further comprising submitting payment information that includes a credit card number and expiration date.

11. The method according to claim 8 wherein said DVD preview step further comprises explicitly requesting user confirmation that all spelling in the text fields is correct.

12. The method according to claim 8 wherein said DVD preview step further comprises explicitly requesting user confirmation that the correct image(s) have been selected for printing.

13. The method according to claim 8 wherein said electronic submission steps further comprise submitting the DVD order, the cover image(s), the text field(s) and the digital content files over the Internet.
